(19) United States
(12) Patent Application Publication
(10) Pub. No.: US 2024/0037679 A1
(43) Pub. Date: Feb. 1, 2024

(54) TOURISM SUPPORT DEVICE

(71) Applicant: TOYOTA JODOSHA KABUSHIKI KAISHA, Toyota-shi Aichi-ken (JP)

(72) Inventors: Tomoyuki KURIYAMA, Inagi-shi Tokyo (JP); Hinata ICHIKAWA, Nagoya-shi Aichi-ken (JP)

(73) Assignee: TOYOTA JODOSHA KABUSHIKI KAISHA, Toyota-shi Aichi-ken (JP)

(21) Appl. No.: 18/143,865

(22) Filed: May 5, 2023

(30) Foreign Application Priority Data
Jul. 28, 2022 (JP) 2022-120947

(51) Int. Cl. G06Q 50/14; G06F 3/04842; G06Q 10/02; G01C 21/36

(52) U.S. Cl. CPC G06Q 50/14; G06F 3/04842; G06Q 10/02; G01C 21/367

(57) ABSTRACT

The tourism support device includes a reception unit that receives a selection of an area by a user and a destination in the area, a display unit that displays an icon for receiving a selection of a purpose including a map of the area and a movement unit, a control unit that performs control to superimpose a marker on the map at a position where the purpose can be achieved in accordance with the selected purpose, and a presentation unit that presents the movement unit and the tourist spot recommended in the area in accordance with the destination when the purpose related to the movement unit is selected.

### CROSS-REFERENCE TO RELATED APPLICATION

This application claims priority to Japanese Patent Application No. 2022-120947 filed on Jul. 28, 2022 incorporated herein by reference in its entirety.

### BACKGROUND

### 1. Technical Field

The present disclosure relates to a tourism support device that presents a tourist spot.

### 2. Description of Related Art

Japanese Unexamined Patent Application Publication No. 2011-227827 (JP 2011-227827 A) discloses a system for searching for a traveling route having a minimum traveling distance in consideration of time attribute information including business hours of tourist resources and holidays when traveling through a plurality of tourist spots.

### SUMMARY

In the related art, since it is necessary to designate a spot to be visited in advance when touring a region, it is possible to visit a tourist spot in a range examined in advance.

However, it was not always possible to visit tourist spots that would not be known to those who visited the region for the first time.

An object of the present disclosure is to provide a tourism support device capable of visiting a tourist spot that cannot be known to a person who visits the region for the first time, when touring the region.

The tourism support device according to a first aspect includes: a reception unit that receives a selection of a region by a user and a destination in the region; a display unit that displays an icon for receiving a selection of a target including a map of the region and an arrangement of a moving unit; a control unit that performs control for superimposing a marker on the map at a position where the target is achievable in accordance with the selected target; and a presentation unit that presents the moving unit and a tourist spot recommended in the region in accordance with the destination, when the target related to the arrangement of the moving unit is selected.

The tourism support device according to the first aspect superimposes and displays a marker on a map of the selected region at a position where the selected target can be achieved, and when the marker related to the arrangement of the moving unit is selected, the tourism support device presents the destination in the region and the tourist spot in accordance with the moving unit. This enables visitors to visit tourist spots that cannot be known to visitors who visit the region for the first time, when touring the region.

In the tourism support device according to a second aspect, in the tourism support device according to the first aspect, the reception unit receives a selection of a depopulated region as the region.

According to the tourism support device of the second aspect, even a tourist spot with a low recognition degree can be visited.

In the tourism support device according to a third aspect, in the tourism support device according to the first aspect or the second aspect, the reception unit further receives a reservation of the moving unit indicated by the marker, when the target related to the arrangement of the moving unit is selected.

According to the tourism support device of the aspect, it is possible to secure in advance a moving unit for visiting the destination and the tourist spot.

In the tourism support device according to a fourth aspect, in the tourism support device according to any one of the first aspect to the third aspect, the presentation unit presents a time zone in which the target is achievable.

According to the tourism support device of the fourth aspect, it is possible to recognize a time zone in which a moving unit, a joint facility, and the like are available.

In the tourism support device according to a fifth aspect, in the tourism support device according to any one of the first aspect to the fourth aspect, the reception unit further receives a selection of a subject including a resident of the region and a visitor of the region, and the display unit displays the map and the icon corresponding to the subject.

According to the tourism support device of the fifth aspect, it is possible to control the marker displayed on the map, and the display of the destination and the like in accordance with the subject user.

According to the present disclosure, visitors can visit tourist spots that cannot be known to visitors who visit the region for the first time, when touring the region.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating an example of a hardware configuration of a terminal according to the present embodiment;

FIG. 2 is a block diagram illustrating an example of a functional configuration of a terminal according to the present embodiment;

FIG. 3 is a schematic diagram illustrating an example of a target selection screen according to the present embodiment;

FIG. 4 is a schematic diagram illustrating an example of a map display screen according to the present embodiment;

FIG. 5 is a schematic diagram illustrating an example of a map display screen used for describing a recommended moving unit and a presentation of a tourist spot according to the present embodiment;

FIG. 6 is a schematic diagram illustrating an example of a map display screen used for describing presentation of detailed information of the present embodiment;

FIG. 7 is a flowchart illustrating an example of a process of presenting a tourist spot according to the present embodiment; and

FIG. 8 is a flowchart illustrating an example of a process of presenting information according to the present embodiment.

### DETAILED DESCRIPTION OF EMBODIMENTS

A tourism support device mounted on a terminal of the present disclosure will be described.

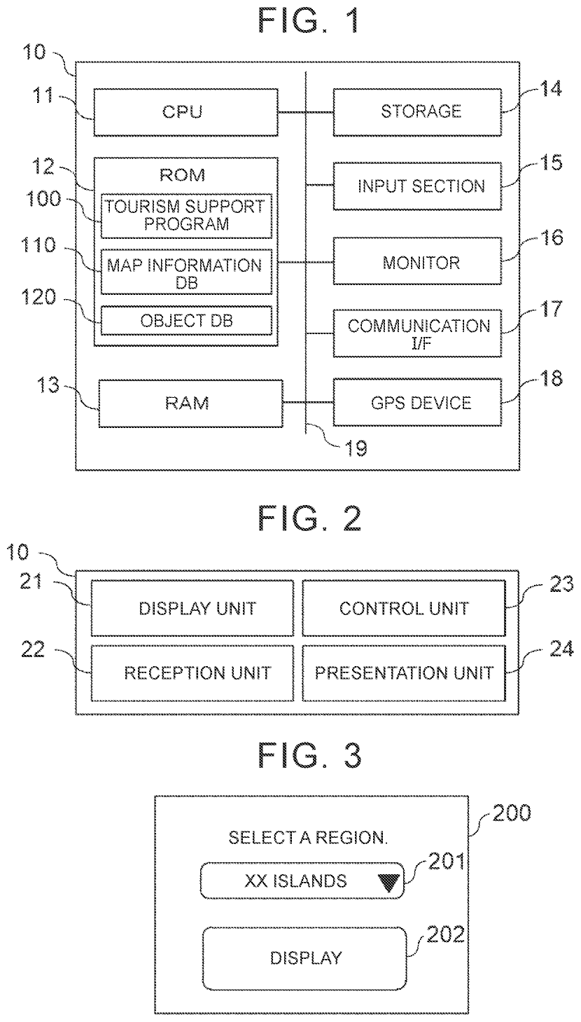

FIG. 1 is a block diagram illustrating an example of a hardware configuration of a terminal 10 according to the present embodiment. As illustrated in FIG. 1, the terminal 10 according to the present embodiment includes a Central Processing Unit (CPU) 11, Read Only Memory (ROM) 12, Random Access Memory (RAM) 13, a storage 14, an input unit 15, a monitor 16, and a communication interface (communication I/F) 17 and Global Positioning System (GPS) device 18. CPU 11, ROM 12, RAM 13, the storages 14, the input unit 15, the monitor 16, the communication I/F 17, and GPS device 18 are connected to each other by a bus 19.

CPU 11 is a central processing unit that executes various programs and controls each unit. That is, CPU 11 reads the program from ROM 12 and executes the program using RAM 13 as a working area.

ROM 12 stores various programs and various data. In ROM 12 of the present embodiment, a tourism support program 100 that presents tourist spots corresponding to destinations and transportation units, and a map information database (DB) 110 and target object DB 120 are stored. Upon execution of the tourism support program 100, the terminal 10 executes a process of presenting a tourist spot corresponding to the destination and the moving unit. RAM 13 temporarily stores a program/data as a working area.

Storage 14 may be, for example, Hard Disk Drive (HDD), Solid State Drive (SSD), or flash memory. Various programs and the like may be stored in the storage 14.

The input unit 15 is a touch panel, a button, or the like that accepts input of characters, selection of icons, and the like. The monitor 16 displays characters and images. The communication I/F 17 is a radio communication module for communicating with an external center server or the like. For example, a communication standard such as 5G, LTE, Wi-Fi (registered trademark) is used as the radio communication module.

GPS device 18 is a device that receives position data such as the present location of the terminal 10 positioned by a plurality of GPS satellites. GPS device 18 includes antennae (not shown) for receiving positioning data from GPS satellites.

The map information DB 110 stores map information related to a depopulated region, and the target DB 120 stores detailed information of a target such as a facility and a tourist spot in the depopulated region. In the present embodiment, a mode in which a depopulated region having a low population density can be selected as a region will be described. However, it is not limited thereto. As a region, a selection of an urban area having a high population density may be accepted.

As illustrated in FIG. 2, in the terminal 10 of the present embodiment, CPU 11 executes the tourism support program 100 to function as the display unit 21, the reception unit 22, the control unit 23, and the presentation unit 24.

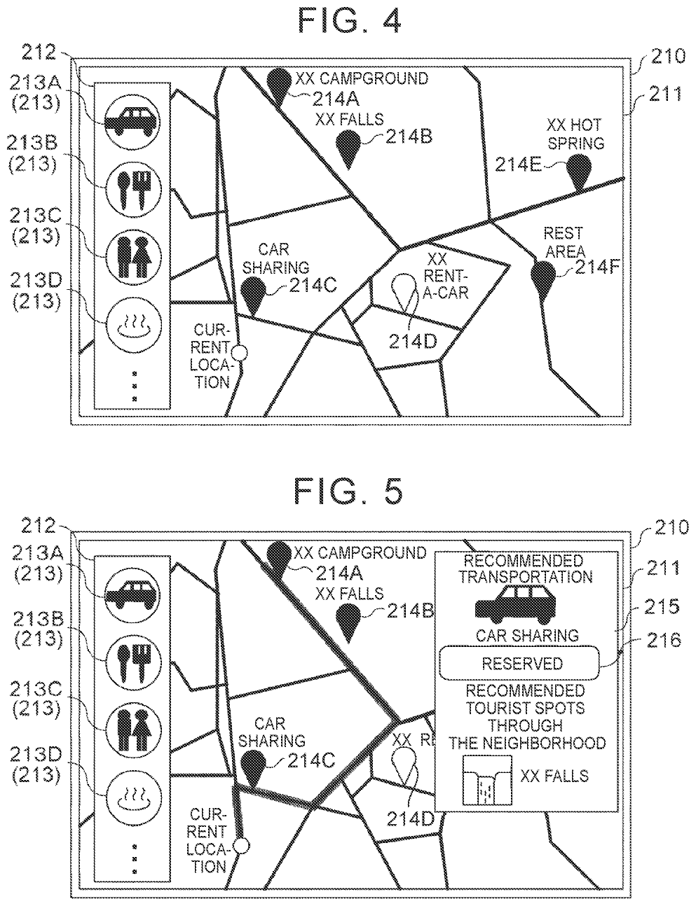

The display unit 21 displays a target selection screen 200 illustrated in FIG. 3 as an example and a map display screen 210 illustrated in FIGS. 4 to 6 as an example.

The target selection screen 200 illustrated in FIG. 3 includes a region selection pull-down 201 and a display button 202. The area selection pull-down 201 is a pull-down for receiving a selection of a target area, and the display button 202 is a button for receiving an instruction for displaying map information related to the selected area.

The map display screen 210 illustrated in FIGS. 4 to 6 includes a map display area 211 and an icon display area 212. The map display area 211 is an area for displaying the map information of the area selected by the user, and the icon display area 212 displays an icon 213 for accepting the target selection. For example, the icon 213 accepts whether or not a marker 214 (214A, 214B, 214C, 214D, 214E, and/or 214E) indicating a target object that can be achieved by a purpose including an arrangement of a moving unit, a public facility such as a restaurant or a toilet, and a sightseeing spot such as a landscape spot is displayed on a map. Specifically, as illustrated in FIG. 4, the map display screen 210 displays the unit icon 213A, the restaurant icon 213B, the joint facility icon 213C, and the tourist spot icon 213D in the icon display area 212. In response to the selected icon 213, the map display screen 210 displays the marker 214 corresponding to the icon 213 at a position corresponding to the map display area 211.

The reception unit 22 accepts selection of a region by the user and designation of a destination in the selected region. In addition, when the marker 214 related to the arrangement of the moving unit is selected, the reception unit 22 accepts the reservation of the moving unit. Note that the reception unit 22 may accept the designation of the destination when the marker 214 is selected by the user, or may accept the designation of the destination by an input field (not shown).

The control unit 23 performs control to superimpose the marker 214 on the map at a position corresponding to (achievable by) the selected icon 213 in accordance with the selected icon 213 (target). For example, as illustrated in FIG. 4, when the user selects the moving unit icon 213A, the control unit 23 performs control of displaying the marker 214 at a position where the moving unit is obtained, such as a station on the train and a place where a vehicle or a bicycle can be rented.

In addition, the control unit 23 grays out the target marker 214 at the present time when the purpose is not achievable. For example, in a case where the moving unit icon 213A is selected by the user, when the current time has passed the business hours of the rental car shop, the control unit 23 performs control of displaying the marker 214 indicating the rental car shop in a grayed-out manner and superimposing the marker on the map in such a manner that the target cannot be achieved.

When the moving unit icon 213A is selected, the presentation unit 24 presents the moving unit and the tourist spots recommended in the region according to the designated destination.

For example, when the moving unit icon 213A is selected on the map display screen 210 illustrated in FIG. 5 and the designation of the destination is received from the user, the presentation unit 24 presents the recommended moving unit on the basis of the positional relation between the current location and the destination and the surrounding information of the destination. The recommended moving unit is presented according to the distance from the current location to the destination, the type of the moving unit, and the like.

Here, the presentation unit 24 presents a tourist spot that can be visited and recommended by the moving unit together with the recommended moving unit. Specifically, the presentation unit 24 derives a route to the destination in the case where the recommended moving unit is used from the current location, displays a tourist spot located in the vicinity of the route in the recommended object presentation area 215, and presents the recommended moving unit and the tourist spot. Here, the presentation unit 24 displays the reservation button 216 in the recommended object presentation area 215, and the reception unit 22 receives the reservation of the moving unit when the reservation button 216 is pressed.

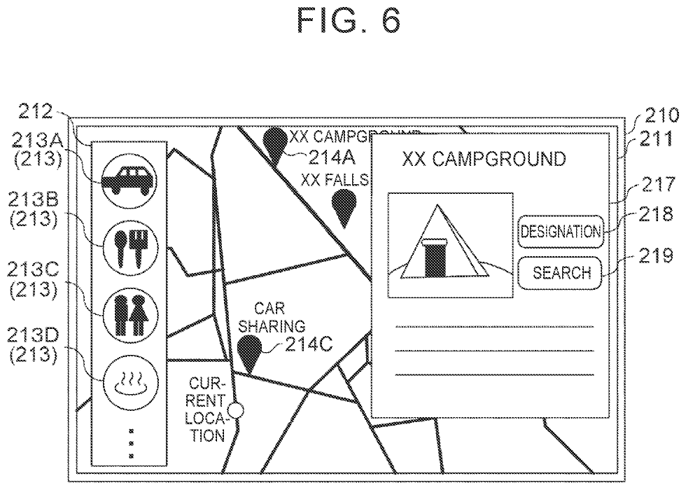

When the user selects the marker 214 on the map display screen 210, the presentation unit 24 presents details of the target object indicated by the marker 214. As illustrated in FIG. 6 as an example, when the marker 214 that can be a destination is selected, the presentation unit 24 displays the detailed information area 217 on the map display screen 210 as the details of the target object indicated by the marker 214. Here, the presentation unit 24 displays the designation button 218 and the search button 219 in the detailed information area 217 together with the description of the target object and the like. The designation button 218 is a button for receiving a target object indicated by the marker 214 as a destination. The search button 219 is a button for receiving a search for a sightseeing spot located in the vicinity of the target object. The reservation button 216 is a button for receiving a reservation of a moving unit for moving to the target object. Here, when the designation button 218 is pressed, the reception unit 22 receives the target object indicated by the marker 214 as a destination, and the presentation unit 24 derives a route to the destination in a case where the recommended moving unit is used from the current location, and presents the recommended moving unit and the tourist spot. Further, when the search button 219 is pressed, the reception unit 22 receives an instruction to search for a sightseeing spot located in the vicinity of the target, and the presentation unit 24 presents a recommended sightseeing spot located in the vicinity of the target. Note that the presentation unit 24 according to the present embodiment has described a mode in which the designation button 218, the search button 219, and the like are presented. However, it is not limited thereto. A time period in which the object can be achieved may be presented. For example, when the marker 214 indicating the rental car shop, the marker 214 indicating the restaurant, and the like are selected, the presentation unit 24 may present the business hours of the rental car shop and the restaurant.

### Control Flow

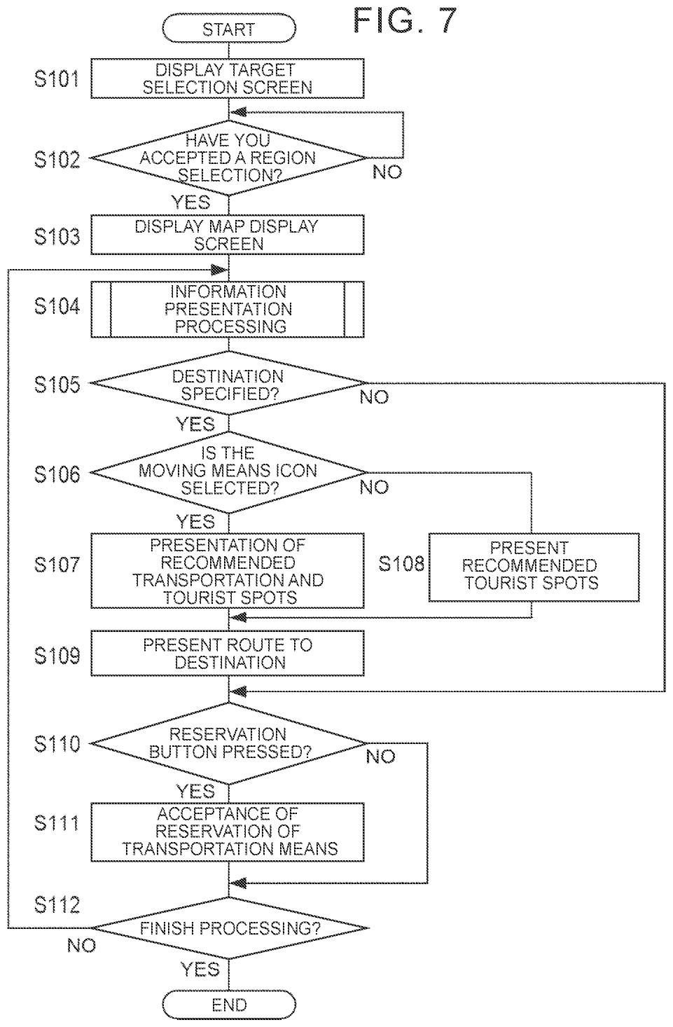

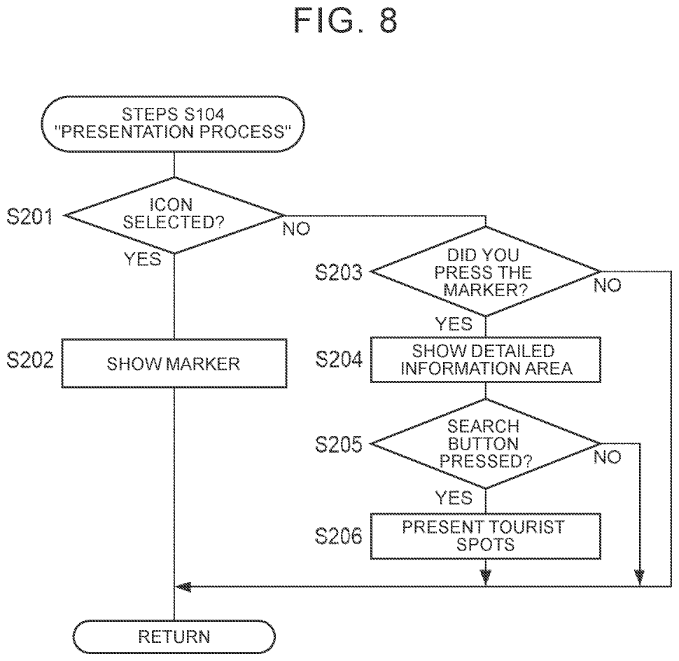

A flow of processing executed by the terminal 10 of the present embodiment will be described with reference to the flowcharts of FIG. 7 and FIG. 8. The process in the terminal 10 is executed by CPU 11 of the terminal 10 functioning as the display unit 21, the reception unit 22, the control unit 23, and the presentation unit 24. The process of presenting the sightseeing spot according to the destination and the moving unit illustrated in FIG. 7 is executed, for example, when an instruction to present the sightseeing spot is input.

In S101, CPU 11 displays a target selection screen 200.

In S102, CPU 11 determines whether or not the selection of a region has been accepted in the target selection screen 200. When the selection of the region is accepted (S102: YES), CPU 11 shifts to S103. On the other hand, when the selection of the region is not accepted (S102: NO), CPU 11 stands by until the selection of the region is accepted.

In S103, CPU 11 displays a map display screen 210, a map display area 211, an icon display area 212, and respective icons 213.

In S104, CPU 11 executes an information-presenting process. The information presentation processing will be described in detail later with reference to FIG. 8.

In S105, CPU 11 determines whether or not the destination is designated. If the destination is specified (S105: YES), CPU 11 transitions to S106. On the other hand, if no destination is specified (S105: NO), CPU 11 proceeds to S110.

In S106, CPU 11 determines whether or not the moving unit icon 213A is selected. When the moving unit icon 213A is selected (S106: YES), CPU 11 proceeds to S107. On the other hand, when the moving unit icon 213A is not selected (S106: NO), CPU 11 proceeds to S108.

In S107, CPU 11 displays the recommended object presentation area 215 to present the recommended moving unit and the tourist spots that can be visited and recommended by the moving unit.

In S108, CPU 11 displays the recommended object presentation area 215 to present the recommended tourist spots.

In S109, CPU 11 presents a route from the current location to the destination.

In S110, CPU 11 determines whether or not the reservation button 216 has been pressed. When the user presses the reservation button 216 (S110: YES), CPU 11 shifts to S111. On the other hand, when the reservation button 216 is not pressed (S110: NO), CPU 11 proceeds to S112.

In S111, CPU 11 receives an appointment of the moving unit.

In S112, CPU 11 determines whether or not to terminate the process of presenting the tourist spots. When the process is terminated (S112: YES), CPU 11 terminates the process. On the other hand, if the process is not terminated (S112: NO), CPU 11 proceeds to S104 and executes the information-presenting process.

Next, the information presentation processing will be described with reference to FIG. 8. The process of presenting the information illustrated in FIG. 8 is executed, for example, when an icon or a marker 214 is pressed on the map display screen 210 and an instruction for presenting the information is input.

In S201, CPU 11 determines whether or not the icon 213 is selected on the map-display window 210. When the icon 213 is selected (S201: YES), CPU 11 proceeds to S202. On the other hand, when the icon 213 is not selected (S201: NO), CPU 11 proceeds to S203.

In S202, CPU 11 displays the markers 214 superimposed on the maps according to the selected icons 213. Here, when the object indicated by the marker 214 is not achievable at the present time, CPU 11 performs control of displaying the marker 214 in a grayed-out manner and superimposing it on the map.

In S203, CPU 11 determines whether or not the marker 214 displayed on the map-display window 210 has been selected. If the marker 214 is selected (S203: YES), CPU 11 transitions to S204. On the other hand, when the marker 214 is not selected (S203: NO), CPU 11 ends the information-presenting process.

In S204, CPU 11 displays the detailed information area 217 on the map-display window 210 to present details of the target indicated by the selected marker 214.

In S205, CPU 11 determines whether or not the search button 219 is pressed by being displayed in the detailed information area 217. When the search button 219 is pressed (S205: YES), CPU 11 proceeds to S206. On the other hand, when the search button 219 is not pressed (S205: NO), CPU 11 ends the information-presenting process.

In S206, CPU 11 presents tourist spots located around the target object indicated by the marker 214 in the detailed information area 217.

### SUMMARY OF EMBODIMENTS

The terminal 10 as the tourism support device of the present embodiment displays the marker 214 capable of achieving the selected purpose superimposed on the map of the selected area, and when the marker 214 indicating the moving unit is selected, presents the sightseeing spot according to the destination in the area and the moving unit.

As described above, according to the present embodiment, when touring a region, it is possible to visit a tourist spot that cannot be known to a person who visits the region for the first time.

In the above-described embodiment, a mode in which the tourism support device is mounted on the terminal 10 has been described. However, it is not limited thereto. The tourism support device may be mounted on a server or the like.

Further, in the above-described embodiment, a mode in which selection of a target region is accepted in the target selection screen 200 has been described. However, it is not limited thereto. Selection of a target user may be accepted. For example, the terminal 10 may receive a selection of a resident living in the region and a resident visiting the region on the target selection screen 200, and change the display of the map information, the icon 213, the marker 214 to be displayed, and the like according to the received user.

Further, in the above-described embodiment, the marker 214 is displayed at the position of the target object at which the target object can be achieved in accordance with the selected icon 213 (target object). However, it is not limited thereto. The display of the corresponding marker 214 may be changed according to the selected icon 213 (purpose). For example, a circular marker 214 may be superimposed and displayed on a map as the marker 214 corresponding to the moving unit icon 213A, or a rectangular marker 214 may be superimposed and displayed on a map as the marker 214 corresponding to the tourist spot icon 213D.

Note that various processes executed by CPU 11 reading the software (program) in the above-described embodiment may be executed by various processors other than CPU. Examples of the processor include a Programmable Logic Device (PLD) in which a circuit configuration can be changed after manufacturing of Field-Programmable Gate Array (FPGA), and the like, and a dedicated electric circuit that is a processor having a circuit configuration designed exclusively for executing a particular process such as Application Specific Integrated Circuit (ASIC), and the like. Further, the above-described processes may be executed by one of the various processors, or may be executed by a combination of two or more processors (for example, a plurality of FPGA, a combination of CPU and FPGA, and the like) of the same type or different types. Further, the hardware configuration of the various processors is, more specifically, an electric circuit in which circuit elements such as semiconductor devices are combined.

Further, in the above-described embodiment, each program is stored (installed) in advance in a non-transitory computer-readable recording medium. For example, the tourism support program 100 in the terminal 10 is stored in advance in ROM 12. However, the present disclosure is not limited thereto, and the programs may be provided in a form recorded in a non-transitory recording medium such as Compact Disc Read Only Memory (CD-ROM), Digital Versatile Disc Read Only Memory (DVD-ROM), and Universal Serial Bus (USB). Further, the program may be downloaded from an external device via a network.

The flow of the processing described in the above embodiment is an example, and unnecessary steps may be deleted, new steps may be added, or the processing order may be changed without departing from the gist.

What is claimed is:

1. A tourism support device comprising:
a reception unit that receives a selection of a region by a user and a destination in the region;
a display unit that displays an icon for receiving a selection of a target including a map of the region and an arrangement of a moving unit;
a control unit that performs control for superimposing a marker on the map at a position where the target is achievable in accordance with the selected target; and
a presentation unit that presents the moving unit and a tourist spot recommended in the region in accordance with the destination, when the target related to the arrangement of the moving unit is selected.

2. The tourism support device according to claim 1, wherein the reception unit receives a selection of a depopulated region as the region.

3. The tourism support device according to claim 1, wherein the reception unit further receives a reservation of the moving unit indicated by the marker, when the target related to the arrangement of the moving unit is selected.

4. The tourism support device according to claim 1, wherein the presentation unit presents a time zone in which the target is achievable.

5. The tourism support device according to claim 1, wherein:
the reception unit further receives a selection of a subject including a resident of the region and a visitor of the region; and
the display unit displays the map and the icon corresponding to the subject.
